(19) United States
(12) Patent Application Publication
(10) Pub. No.: US 2006/0182933 A1
(43) Pub. Date: Aug. 17, 2006

(54) Sheet flooring having embedded selvage pattern match indicators

(76) Inventors: Michael E. Buckwalter, New Providence, PA (US); Michael W. Lohr, Mountville, PA (US); Dike S. Stoe, Lancaster, PA (US); Mark C. Zeamer, Columbia, PA (US)

Correspondence Address: ARMSTRONG WORLD INDUSTRIES, INC.;LEGAL DEPARTMENT, P. O. BOX 3001, LANCASTER, PA, 17604-3001, US

(21) Appl. No.: 11/338,092

(22) Filed: Jan. 24, 2006

Related U.S. Application Data
(60) Provisional application No. 60/646,970, filed on Jan. 24, 2005.

(51) Int. Cl. B32B 3/00

(52) U.S. Cl. 428/156

(57) ABSTRACT

Pattern match indicators are embedded in the pattern design in the selvage edge portion of adjacent flooring sheets. The pattern match indicators are spaced apart with the distance between the adjacent pattern match indicators equal to the repeat length of the pattern design. In one embodiment the pattern mark indicators may appear as small bars approximately ¼″ wide and approximately ½″ to approximately ⅝″ in length. Prior to cutting off the selvage edge portions, the adjacent flooring sheets are laid with the edge portion of one flooring sheet overlapping the other flooring sheet. The pattern match indictors are located with the pattern match indicators collinear with respect to the across-machine direction and with a gap of predetermined dimension between them. With the flooring sheets overlapped, the selvage edge portions are simultaneously cut parallel to the longitudinal edges of the flooring sheets and within the gap between the pattern match indicators,

The present invention relates to a flooring sheet having a pattern design and a method of installing a plurality of the flooring sheets. The flooring sheets have a selvage edge portion adjacent a longitudinal edge of the flooring sheet, which selvage edge portion is cut off as the flooring sheet is installed. The selvage edge portion has a portion of the pattern design and a plurality of pattern match indicators embedded in the pattern design of the selvage edge portion.

### BACKGROUND OF THE INVENTION

Pattern sheet flooring typically has a repeating design pattern printed on the exposed surface. It is desirable to line up the patterns of adjacent sheets as they are being installed so that the patterns are aligned and the seam between the adjacent sheets becomes less noticeable.

If the pattern includes grout lines to give the appearance of tile, it is fairly easy to align the adjacent sheets prior to trimming the selvage edge portions and adhering the sheet to the substrate on which they are laid. However, if the pattern repeat is less obvious, such as when the patterns include only non-geometric patterns, correctly aligning the adjacent sheet becomes more difficult. The repeat pattern must be identified in both sheets and then the sheets moved with the selvage edges overlapping and with the patterns of both sheets being aligned. Both selvage edge portions are then severed with a single cut so that when severed selvage edge portions are removed, a butt joint remains with the patterns aligned.

Many sheets include selvage edge portions in which the printed pattern does not extend to the edges of the sheets. Therefore, there is typically a white, unprinted portion adjacent the edges on which manufacturing marks are printed. Typically, the trademark of the manufacturer is printed in the unprinted portion of one selvage edge portion.

The flooring sheets are typically laid out as they come off the core on which they are stored without rotating the sheets so that the trademark edge of a first sheet is adjacent the non-trademark edge of the adjacent sheet. Sometimes the manufacturing marks in the unprinted selvage edge portions can be used to help align the adjacent flooring sheets longitudinally. However, the marks in the unprinted selvage edge portions are not designed to align the adjacent flooring sheets so that the patterns match transverse, i.e. in the across-machine direction.

### SUMMARY OF THE INVENTION

The pattern match indicators of the present invention are embedded in the pattern design in the selvage edge portion of the flooring sheets. Therefore, alignment between the pattern match indicators and the pattern design is assured. The pattern match indicators are spaced apart with the distance between the adjacent pattern match indicators equal to the repeat length of the pattern design or a multiple of the repeat length.

A second plurality of pattern match indicators are embedded in the opposed selvage edge portion. The pattern match indicators are located whereby, when the selvage edge portions of adjacent flooring sheets are overlapped with the pattern match indicators collinear with respect to the across-machine direction and a gap of predetermined dimension between them, the pattern designs of the two flooring sheets are aligned.

In one embodiment, the pattern match indicators are the same color as the darkest ink used in the design pattern. Therefore, while the pattern match indicators are readily apparent to the installer, if the pattern match indicator is inadvertently left exposed on the installed flooring sheet, it tends to blend in with the pattern design and is not objectionable to the consumer.

In some embodiments, the pattern match indicators are embossed depressions. This is done to further aid locating by the installer.

In another embodiment, when the pattern match indicators are positioned so that a pattern match indicator on one flooring sheet overlies the pattern match indicator of the adjacent sheet, the pattern designs of the adjacent sheets are aligned. In this embodiment, when the selvage edge portions are simultaneously severed, at least a portion of some of the pattern match indicators will remain on the exposed surface of the installed flooring sheets.

### BRIEF DESCRIPTION OF THE DRAWINGS

FIG. 1 is a fragmentary perspective view of the flooring sheets showing the pattern mark indicators.

FIG. 2 is a fragmentary perspective view of the flooring sheets of FIG. 1 showing the selvage edge portions bounded by dotted lines.

FIG. 3 is a fragmentary side view of the flooring sheets showing the pattern mark indicators and the cut line being indicated by a dotted line.

### DETAILED DESCRIPTION OF THE INVENTION

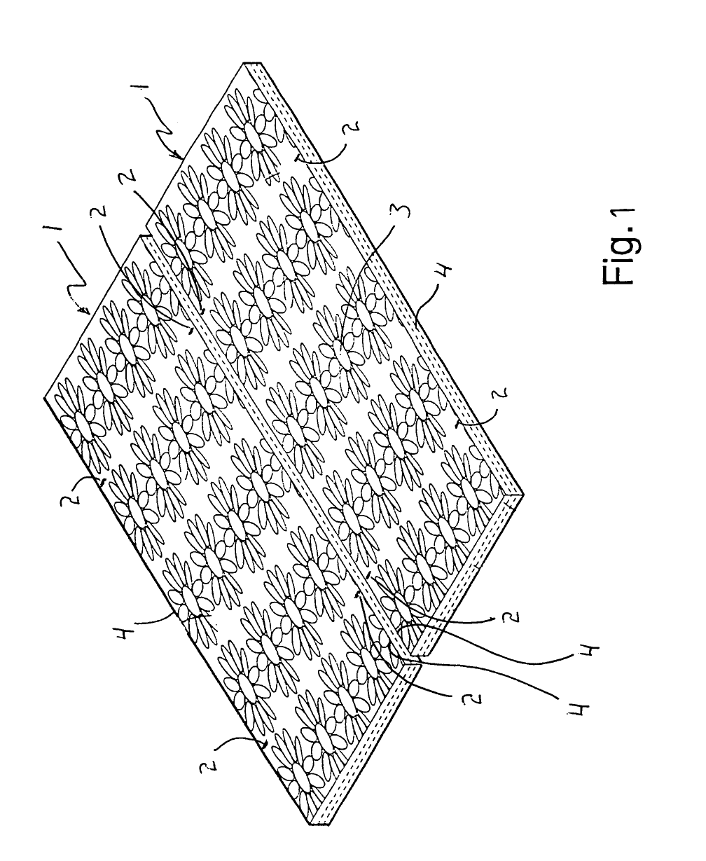

The present invention is directed to a flooring sheet having a pattern design and a method of installing a plurality of the flooring sheets. As shown in FIG. 1, the flooring sheets 1 have a plurality of pattern match indicators 2 embedded in the pattern design 3 adjacent the longitudinal edges 4.

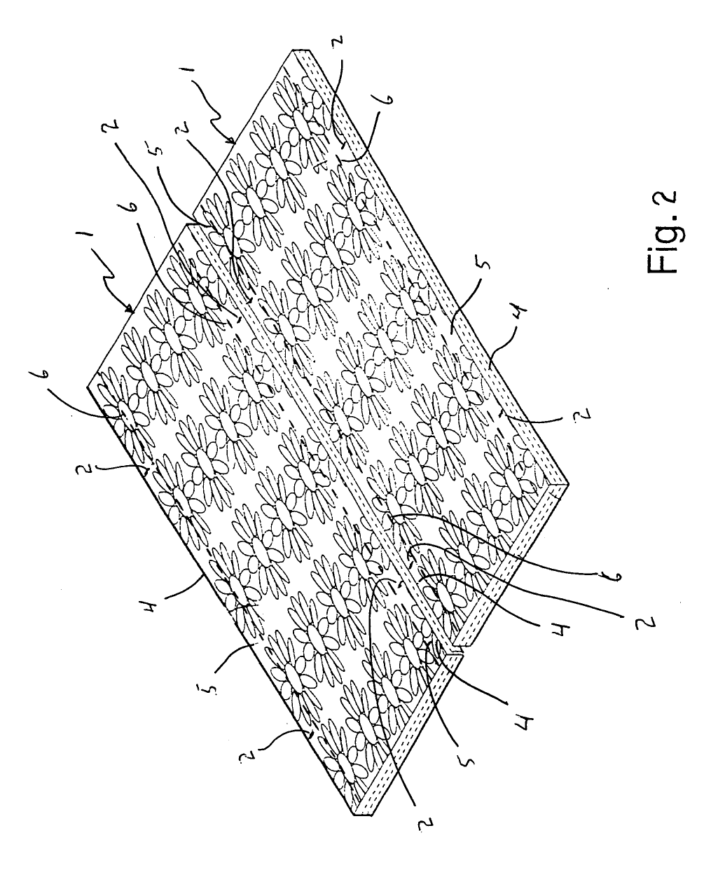

As shown in FIG. 2, the selvage edge portions 5 adjacent the longitudinal edges 4 of the flooring sheets 1 are bounded by dotted lines 6. During installation the selvage edge portions 5 (shown in FIG. 2) are cut off, the longitudinal edges of the flooring sheets butted together and the flooring sheets adhered to the substrate.

In certain patterns, particularly non-geometric patterns without grout lines, the pattern match indicators 2 printed in the selvage edge portions 5 help installers quickly locate the pattern repeat, cut flooring sheet 1 accurately to take to jobs, line up the pattern designs of two adjacent flooring sheets 1 at the seams and locate the proper place to cut the seam. The pattern match indicators 2 take the guesswork out of these steps, save time in the installation process and allow for the best possible pattern match at the seams.

The pattern mark indicators 2 may appear as small bars approximately ¼″ wide and approximately ½″ to approximately ⅝″ in length and occur along both longitudinal edges of the flooring sheet 1. The bars were printed with the darkest ink used in each of the pattern colorations and appear as a flat embossed mark. The color match helps hide any pattern match indicators that inadvertently remain when the selvage edge portion is removed. The embossing helps the installer to locate the pattern match indicator in the pattern design.

Use of the pattern match indicators do not change the standard good practices that should be followed when installing multiple pieces of flooring, such as rolling each piece individually on the same size core to take to the jobsite, installing pieces consecutively as they come off of the customer roll. The pattern match indicators 2 will be cut off along with the rest of the selvage edge portions 5 when the seam is cut properly.

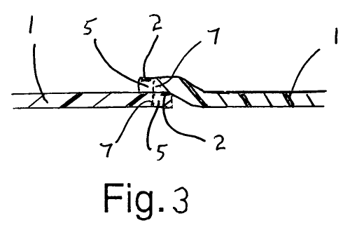

Prior to cutting off the selvage edge portions, the adjacent flooring sheets are laid with the edge portion of one flooring sheet overlapping the other flooring sheet, as shown in FIG. 3. The pattern match indictors 2 are located with the pattern match indicators collinear with respect to the across-machine direction and with a gap of predetermined dimension between them.

In one embodiment the gap is approximately equal to the width of the pattern match indicators. Therefore, if the width of the pattern match indicators is about ¼″, the gap is also about ¼″. With the flooring sheets 1 overlapped, the selvage edge portions 5 are simultaneously cut parallel to the longitudinal edges and within the gap between the pattern match indicators, such as along the dotted line 7 shown in FIG. 3. That is the flooring sheets are cut about ⅛″ into the pattern design from the end of the pattern match indicators distal the adjacent longitudinal edge.

This means, when double cutting a seam, the trademarked edge of the second flooring sheet is overlapped on top of the non-trademarked edge of the first flooring sheet so that the inside end of the pattern match indicator of the second flooring sheet overlaps the inside end of the pattern match indicator of the first flooring sheet by about ¼″.

Since the pattern match indicator are ¼″ wide, and this will provide a visual reference for judging the correct amount of overlap of the two flooring sheets. A straightedge is positioned ⅛″ away from the distal ends of the pattern match indicators on the top flooring sheet and the seam is cut along the straightedge. If flooring sheets are overlapped properly, this seam cut will also be ⅛″ away from the distal end of the pattern match indicator on the bottom flooring sheet. Both top and bottom pattern match indicators will be removed along with an additional ⅛″ of pattern along both sides of the seam.

For those installers who straight edge and butt seams, the straight edge should be positioned so that the cut is made ⅛″ away from the distal end of the pattern match indicators on both sides of the seam. This will assure proper match at the seam.

If a factory edge of the sheet is butted along a straight wall to start the job, the wall base or moldings should cover the indicators so that they are not visible in the finished installation.

In another embodiment, if the pattern match indicators are positioned so that a pattern match indicators on one flooring sheet directly overlies the pattern match indicator of the adjacent sheet, the pattern designs of the adjacent sheets will be aligned. In this embodiment, when the selvage edge portions are simultaneously severed, at least a portion of some of the pattern match indicators will remain on the exposed surface of the installed flooring sheets. However, depending on the color and size of the pattern match indicators and the design pattern of the flooring sheets, this may not be objectionable. Further, to assist in aligning the pattern match indicators, they may be in the shape of crosshairs, circles or bull's-eyes.

1. A flooring sheet comprising a pattern design, a first selvage edge portion adjacent a longitudinal edge of the flooring sheet and a second selvage edge portion adjacent the longitudinal edge of the flooring sheet opposite the first selvage edge portion, the selvage edge portions to be cut off upon installation, the selvage edge portions comprising at least a portion of the pattern design and a plurality of pattern match indicators embedded in the pattern design, the first and second pattern match indicators being located whereby, when the first selvage edge portion of the first flooring sheet overlaps the second flooring sheet with a first pattern match indicator of the first flooring sheet collinear with a second pattern match indicator of the second flooring sheet and a gap between the first pattern match indicator of the first flooring sheet and the second pattern match indicator of the second flooring sheet, the patterns of the first and second flooring sheets are aligned.

2. The flooring sheet of claim 1, wherein the pattern match indicators are the same color as the darkest ink used in the design.

3. The flooring sheet of claim 1, wherein the pattern match indicators are embossed and appear as depressions in the design.

4. The flooring sheet of claim 3, wherein the pattern match indicators are the same color as the darkest ink used in the design.

5. The flooring sheet of claim 1, wherein the distance between the first pattern match indicators and the second pattern match indicators is the same as the repeat length of the design.

6. The flooring sheet of claim 1, wherein the pattern match indicators are about ¼ inch in width and about ½ to about ⅝ inch in length, the length being perpendicular to the longitudinal edge of the flooring sheet adjacent the pattern match indicator.

7. The flooring sheet of claim 1, wherein the pattern design is a non-geometric pattern design.

8. The flooring sheet of claim 1, wherein the width of the gap is about the same as the width of the pattern match indicators.

9. A method of installing flooring sheets of claim 1, comprising overlapping the first selvage edge portion of the first flooring sheet over the second flooring sheet, aligning a first indicator of the first flooring sheet collinear with a second indicator of the second flooring sheet collinearly and with a gap between the two indicators, and then simultaneously cutting off the first and second selvage edge portions, including the first and second indicators, the cut occurring in the gap between the first and second indicators.

10. The method of claim 9, wherein the width of the gap is about the same as the width of the indicators.

11. A flooring sheet comprising a pattern design, a first selvage edge portion adjacent a longitudinal edge of the flooring sheet and a second selvage edge portion adjacent the longitudinal edge of the flooring sheet opposite the first selvage edge portion, the selvage edge portions to be cut off upon installation, the selvage edge portions comprising at least a portion of the pattern design and a plurality of pattern match indicators embedded in the pattern design, the first and second pattern match indicators being located whereby, when the first selvage edge portion of the first flooring sheet overlaps the second flooring sheet with the second pattern match indicator of a second flooring sheet being directly below the first pattern match indicator of the first flooring sheet, the patterns of the first and second flooring sheets are aligned.

12. The flooring sheet of claim 11, wherein the indicators are selected from the group consisting of crosshairs, circles and bull's-eyes.

13. The flooring sheet of claim 10, wherein the pattern match indicators are the same color as the darkest ink used in the design.

14. The flooring sheet of claim 10, wherein the pattern match indicators are embossed and appear as depressions in the design.

15. The flooring sheet of claim 14, wherein the pattern match indicators are the same color as the darkest ink used in the design.

16. The flooring sheet of claim 10, wherein the distance between the first pattern match indicators and the second pattern match indicators is the same as the repeat length of the design.

17. The flooring sheet of claim 1, wherein the pattern design is a non-geometric pattern design.

18. A method of installing flooring sheets of claim 10, comprising overlapping the first selvage edge portion of the first flooring sheet over the second selvage edge portion of a second flooring sheet, aligning a first indicator of the first flooring sheet directly above a second indicator of the second flooring sheet, and then simultaneously cutting off the first and second selvage edges and at least a portion of one of the indicators.

19. The method of claim 18, wherein the indicators are selected from the group consisting of crosshairs, circles and bull's-eyes.
